(19) United States
(12) Patent Application Publication
(10) Pub. No.: US 2026/0278998 A1
(43) Pub. Date: Sep. 17, 2026

(54) OBJECT DETECTION

(71) Applicant: TENCENT TECHNOLOGY (SHENZHEN) COMPANY LIMITED, Shenzhen (CN)

(72) Inventors: Jiawei ZHAN, Shenzhen (CN); Jun LIU, Shenzhen (CN); Jianwu WANG, Shenzhen (CN); Chengjie WANG, Shenzhen (CN)

(73) Assignee: TENCENT TECHNOLOGY (SHENZHEN) COMPANY LIMITED, Shenzhen (CN)

(21) Appl. No.: 19/677,990

(22) Filed: May 14, 2026

Related U.S. Application Data
(63) Continuation of application No. PCT/CN2024/136709, filed on Dec. 4, 2024.

(30) Foreign Application Priority Data
Jan. 9, 2024 (CN) 202410029363.1

(51) Int. Cl. G06V 10/28; G06V 10/25; G06V 10/762; G06V 10/764; G06V 10/766; G06V 10/77; G06V 10/82

(52) U.S. Cl. CPC G06V 10/28; G06V 10/762; G06V 10/764; G06V 10/766; G06V 10/7715; G06V 10/82; G06V 10/25; G06V 2201/06; G06V 2201/07

(57) ABSTRACT

In an object detection method example, one or more candidate target object detection boxes in a to-be-detected image are obtained by using an object detection model. For each candidate target object detection box, a first grayscale representative value of first pixels in the candidate target object detection box is determined, and a second grayscale representative value of second pixels in a background region of the candidate target object detection box is determined, the background region is a region with a predetermined range surrounding the candidate target object detection box. A grayscale contrast between the first grayscale representative value and the second grayscale representative value is determined. A detection result of the to-be-detected image is obtained based on the grayscale contrasts of the one or more candidate target object detection boxes and a preset condition. Apparatus and non-transitory computer-readable storage medium counterpart embodiments are also contemplated.

### RELATED APPLICATIONS

The present application is a continuation of International Application No. PCT/CN2024/136709, filed on Dec. 4, 2024, which claims priority to Chinese Patent Application No. 202410029363.1, filed on Jan. 9, 2024. The entire disclosures of the prior applications are hereby incorporated by reference.

### FIELD OF THE TECHNOLOGY

This disclosure relates to the field of image processing technologies, including an object detection method and apparatus, an electronic device, and a storage medium.

### BACKGROUND

With the development of emerging technologies such as artificial intelligence and deep learning, it has become a very common means to detect a target object by using these technologies. A deep learning method has advantages such as a high detection rate, strong generalization performance, and being capable of being promoted at low costs after a model is stable. However, a related deep network method may suffer from an over-detection problem. For example, for a defect detection scenario, if slight stains of light gray appear on a gray interface, the defect may be detected. However, the defect is not visually significant. That is, the related deep network method may not effectively distinguish between a visually significant defect and a visually insignificant defect, resulting in a high incidence of over-detection.

### SUMMARY

An objective of embodiments of this disclosure addresses an over-detection problem of object detection.

Some aspects of the disclosure provide a method of object detection. In some examples, in a to-be-detected image, one or more candidate target object detection boxes are obtained by using an object detection model, the one or more candidate target object detection boxes respectively include a target object that is recognized by using the object detection model. For each candidate target object detection box in the one or more candidate target object detection boxes, a first grayscale representative value of first pixels in the candidate target object detection box is determined, and a second grayscale representative value of second pixels in a background region of the candidate target object detection box is determined, the background region is a region with a predetermined range surrounding the candidate target object detection box. A grayscale contrast of the candidate target object detection box between the first grayscale representative value and the second grayscale representative value is determined. A detection result of the to-be-detected image is obtained based on the grayscale contrasts of the one or more candidate target object detection boxes and a preset condition.

Some aspects of the disclosure provide an apparatus of object detection. The apparatus includes processing circuitry configured to obtain, in a to-be-detected image, one or more candidate target object detection boxes that respectively include a target object that is recognized by using an object detection model. For each candidate target object detection box in the one or more candidate target object detection boxes, the processing circuitry is configured to determine a first grayscale representative value of first pixels in the candidate target object detection box, determine a second grayscale representative value of second pixels in a background region of the candidate target object detection box, the background region being a region with a predetermined range surrounding the candidate target object detection box, and determine a grayscale contrast of the candidate target object detection box between the first grayscale representative value and the second grayscale representative value. Also, the processing circuitry is configured to obtain a detection result of the to-be-detected image based on the grayscale contrasts of the one or more candidate target object detection boxes and a preset condition.

Some aspects of the disclosure also provide a non-transitory computer-readable storage medium storing instructions which when executed by at least one processor cause the at least one processor to perform the method of object detection.

Some aspects of this disclosure provide an object detection method. The method is performed by an electronic device and includes: recognizing a target object in a to-be-detected image by using an object detection model, to obtain at least one target object detection box; for each target object detection box, determining a first grayscale representative value of pixels in the target object detection box, determining a second grayscale representative value of pixels in a background region of the target object detection box, and determining a grayscale contrast between the first grayscale representative value and the second grayscale representative value, the background region being a region with a predetermined range surrounding the target object detection box; and determining a target object detection box whose grayscale contrast satisfies a preset condition in the at least one target object detection box as a detection result of the to-be-detected image.

Some aspects of this disclosure provide an object detection apparatus. The apparatus includes: a target object recognition module, configured to recognize a target object in a to-be-detected image by using an object detection model, to obtain at least one target object detection box; a contrast determining module, configured to: for each target object detection box, determine a first grayscale representative value of pixels in the target object detection box, determine a second grayscale representative value of pixels in a background region of the target object detection box, and determine a grayscale contrast between the first grayscale representative value and the second grayscale representative value, the background region being a region with a predetermined range surrounding the target object detection box; and a detection result determining module, configured to determine a target object detection box whose grayscale contrast satisfies a preset condition in the at least one target object detection box as a detection result of the to-be-detected image.

Some embodiments of this disclosure provide an electronic device. The electronic device includes a memory, a processor (an example of processing circuitry), and a computer program stored in the memory, and the processor executing the computer program to implement the data processing method provided in embodiments of this disclosure.

Some embodiments of this disclosure provide a computer-readable storage medium (for example, a non-transitory computer-readable storage medium), having a computer program stored therein. The computer program is executed by a processor to implement the data processing method provided in embodiments of this disclosure.

Some embodiments of this disclosure further provide a computer program product, including a computer program. The computer program is executed by a processor to implement the data processing method provided in embodiments of this disclosure.

In the object detection method and apparatus, the electronic device, and the storage medium provided in embodiments of this disclosure, a difference between a foreground and a background of a target object detection box is distinguished by using a grayscale contrast between a first grayscale representative value of pixels in the target object detection box and a second grayscale representative value of pixels in a background region with a predetermined range surrounding the target object detection box, to filter out a detection result with an insignificant visual difference, to avoid an over-detection problem.

### BRIEF DESCRIPTION OF THE DRAWINGS

FIG. 1 is a schematic flowchart of an object detection method according to an embodiment of this disclosure.

FIG. 2 is a schematic diagram of an original background region according to an embodiment of this disclosure.

FIG. 3 is a schematic diagram of another original background region according to an embodiment of this disclosure.

FIG. 4 is a schematic diagram of a background region with a surrounding predetermined range according to an embodiment of this disclosure.

FIG. 5 is a schematic diagram of an object detection model according to an embodiment of this disclosure.

FIG. 6 is a schematic diagram of a feature extraction network according to an embodiment of this disclosure.

FIG. 7 is a schematic diagram of a feature fusion network according to an embodiment of this disclosure.

FIG. 8 is a schematic flowchart of a defect detection method according to an embodiment of this disclosure.

FIG. 9 is a schematic diagram of an application scenario of an object detection solution according to an embodiment of this disclosure.

FIG. 10 is a schematic diagram of a structure of an object detection apparatus according to an embodiment of this disclosure.

FIG. 11 is a schematic diagram of a structure of an electronic device according to an embodiment of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

It is noted that, unless stated, singular forms “a”, “an”, and “the” used herein may also include plural forms. The terms “comprise” and “include” used in embodiments of this disclosure refer to corresponding features that can be realized as presented features, information, data, steps, operations, elements, and/or assemblies, but does not exclude the implementation of other features, information, data, steps, operations, elements, assemblies, and/or combinations thereof supported in the art. One element is referred to as “connected” or “coupled” to another element, the element may be directly connected or coupled to another element, or may refer to a connection relationship established between the element and another element through an intermediate element. In addition, “connection” or “coupling” used herein may include wireless connection or wireless coupling. The term “and/or” used herein indicates at least one of the items defined by the term. For example, “A and/or B” indicates an implementation as “A”, an implementation as “B”, or an implementation as “A and B”.

Examples of terms involved in the aspects of the disclosure are briefly introduced. The descriptions of the terms are provided as examples only and are not intended to limit the scope of the disclosure.

(1) Object detection can focus on specific target objects, and aim at separating a target object of interest from a background.

(2) Defect detection is also referred to as anomaly detection, and is a type of object detection, with a main task of determining whether an image has defects.

(3) RGB can represent colors of three channels: Red, Green, and Blue, where various colors are obtained through changes and superposition of the channels of the three colors: Red (R), Green (G), and Blue (B), and can be a storage format and a display format of a photograph captured by a camera. In embodiments of this disclosure, RGB also refers to a common photograph distinguished from a photometric stereo normal vector image.

(4) Grayscale value can refer to a brightness value of each pixel in an image, usually represented by an integer from 0 to 255. A larger grayscale value represents higher brightness of the pixel, and a smaller grayscale value represents lower brightness of the pixel. For example, a grayscale value of 0 represents black, a grayscale value of 255 represents white, and grayscale values ranging between 0 and 255 represent different grayscale levels.

(5) OK/no good (NG) can represent that quality inspection of a workpiece succeeds/fails.

(6) Gaussian distribution, also referred to as normal distribution, is a common continuous probability distribution in fields such as mathematics, physics, and engineering.

A related object detection method may suffer from an over-detection problem. For example, in an industrial manufacturing scenario, technologies such as artificial intelligence and deep learning are related technologies for quality inspection on an appearance of a product, to help ensure consistency, a yield rate, and security of the product, and implement full automation of production line quality inspection. However, current artificial intelligence and deep learning may be unable to meet a requirement of a service side for distinguishing between significant and insignificant defects, resulting in a high incidence of over-detection. Improving a confidence threshold may cause missed detection of some significant defects.

An object detection method and apparatus, an electronic device, and a storage medium provided in this disclosure aim at resolving the foregoing technical problems in the related art.

The following describes the technical solutions of embodiments of this disclosure and technical effects generated by the technical solutions of this disclosure by using descriptions of several implementation examples. The following implementations may be referred to or combined with each other, and the descriptions of the same terms, similar features, and similar implementation operations in different implementations are not be repeated again.

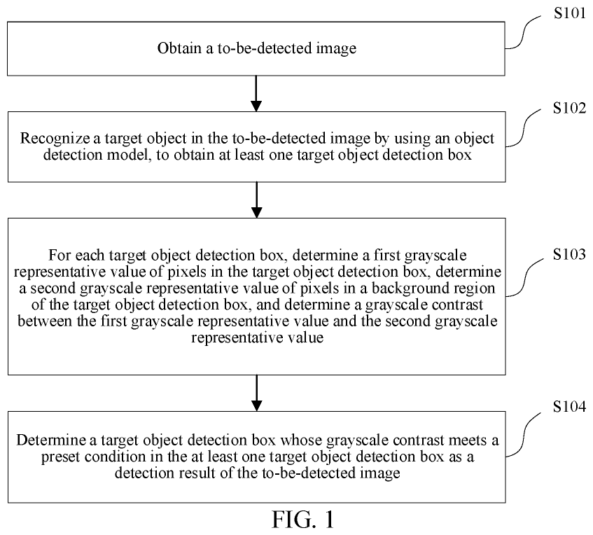

An embodiment of this disclosure provides an object detection method. As shown in FIG. 1, the method includes the following steps.

Operation S101: Obtain a to-be-detected image.

In some embodiments of this disclosure, the to-be-detected image is an image on which target object detection is to be performed. Using a defect detection scenario as an example, the to-be-detected image may be a product image, a product in the image may be an industrial product with a defect to be detected, for example, an industrial part or component, and a target object refers to the defect, but this is not limited thereto. The to-be-processed image may be received from another device, or locally read, or may be photographed in real time. This is not limited in some embodiments of this disclosure. For example, a part of a product or the entire product may be photographed by using a capturing device (for example, a camera), to obtain the to-be-detected image.

Operation S102: Recognize the target object in the to-be-detected image by using an object detection model, to obtain at least one target object detection box.

In some embodiments of this disclosure, a type of the object detection model is not limited. For example, a cascade region-convolutional neural network (Cascade RCNN) model, a faster region-convolutional neural network (Faster RCNN) model, a detection transformer (DETR) model, or the like may be used, but this is not limited thereto.

In some embodiments of this disclosure, the object detection model may understand a foreground, a background, and the like of the to-be-detected image, and determine descriptions of the target object, to obtain classification information (classification) and location information (localization) of the target object.

A region including the recognized target object may be represented by using a rectangular detection box. That is, the target object detection box represents a region in which the recognized target object is located in the to-be-detected image. The location information may be represented by using coordinates of the rectangular detection box, for example, may be represented as center coordinates, a width, and a height (x, y, w, h) of the target object detection box. The classification information of the target object may be represented as a confidence probability, that is, a probability that the target object belongs to various predetermined classifications, and a predetermined classification with a highest probability is selected as the classification information of the target object.

In embodiments, if the object detection model detects a plurality of target objects in the to-be-detected image, an output of the object detection model may be a list, and each item of the list provides classification information and location information of a detected target object by using an array.

Operation S103: For each target object detection box, determine a first grayscale representative value of pixels in the target object detection box, determine a second grayscale representative value of pixels in a background region of the target object detection box, and determine a grayscale contrast between the first grayscale representative value and the second grayscale representative value, the background region being a region with a predetermined range surrounding the target object detection box.

In some embodiments of this disclosure, the first grayscale representative value may represent an overall grayscale condition of all pixels (which may also be referred to as foreground) in the target object detection box. A manner of determining the first grayscale representative value (which may also be referred to as a foreground grayscale value) may be set according to an actual situation. For example, if grayscale values of all the pixels in the target object detection box are monotonous, a grayscale value of one or some pixels in the foreground may be used to represent the first grayscale representative value. For another example, if grayscale values of all the pixels in the target object detection box are numerous and evenly distributed, an average value of the grayscale values of all the pixels in the foreground may be used to represent the first grayscale representative value and the like. This is not limited in some embodiments of this disclosure.

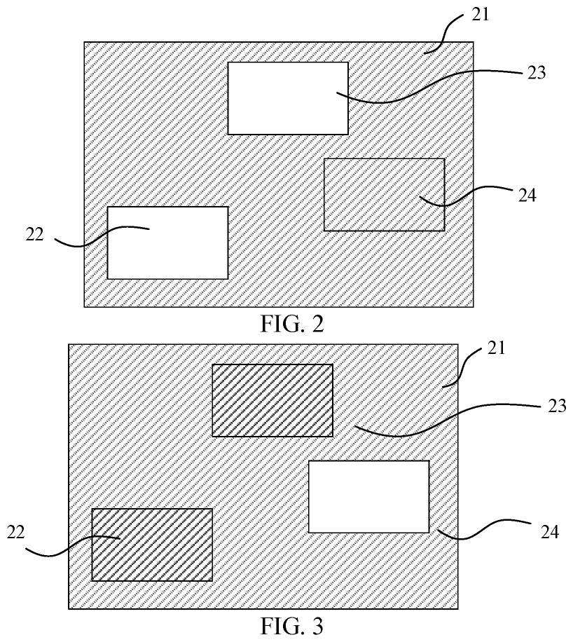

In some embodiments of this disclosure, for a target object detection box, an original background region of the target object detection box is a region excluding detection boxes of the same classification. For example, using a defect detection scenario as an example, as shown in FIG. 2, for a defect 1 region 22 of a classification A, the shadow part is an original background region 21, including a defect 3 region 24 of a classification B and excluding a defect 2 region 23 of the classification A. Alternatively, as shown in FIG. 3, for a defect 3 region 24 of a classification B, the shadow part is an original background region 21, including a defect 1 region 22 of a classification A and a defect 2 region 23 of the classification A.

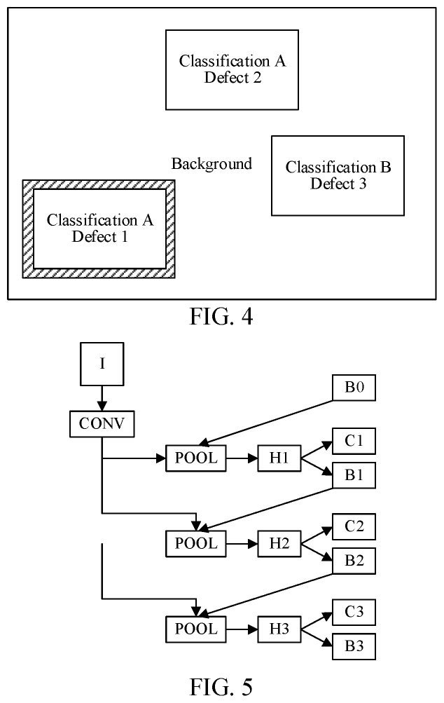

However, considering complexity of the background, for example, in an actual industrial defect detection scenario, a to-be-processed image that usually needs to be detected is a complete device or component, which may include various elements such as a processing workpiece, a machine table, a light source, and a mechanical structure. In this case, using the entire image as the background to calculate the second grayscale representative value may be interfered with by factors such as other structural parts. Therefore, in some embodiments of this disclosure, to reduce interference on the background, a predetermined range surrounding the target object detection box is set as the background region, for example, a region with n=10 pixels surrounding the target object detection box, as shown by the shadow part in FIG. 4. This region has a small probability of including another target object, and therefore may be used as the background region. During actual application, a range of the region may be set according to an actual situation. This is not limited in some embodiments of this disclosure.

In some embodiments of this disclosure, the second grayscale representative value may represent an overall grayscale condition of all the pixels in the background region. A manner of determining the second grayscale representative value (which may also be referred to as a background grayscale value) may alternatively be set according to an actual situation. For example, the second grayscale representative value is represented by using a grayscale value of one or some pixels in the background region, or the second grayscale representative value is represented by using an average value of grayscale values of all the pixels in the background region. This is not limited in some embodiments of this disclosure.

In embodiments, after the first grayscale representative value and the second grayscale representative value are obtained, the grayscale contrast between the first grayscale representative value and the second grayscale representative value may be evaluated, that is, a contrast between the target object and the background is evaluated. A larger grayscale contrast indicates a more significant target object relative to the background. A manner of determining the grayscale contrast may alternatively be set according to an actual situation. For example, a difference between the first grayscale representative value and the second grayscale representative value is calculated, or a difference ratio is calculated. This is not limited in some embodiments of this disclosure.

In some embodiments of this disclosure, such processing is performed on all target object detection boxes, to finally obtain a grayscale contrast corresponding to each target object detection box.

Operation S104: Determine a target object detection box whose grayscale contrast satisfies a preset condition in the at least one target object detection box as a detection result of the to-be-detected image.

The operation may alternatively be understood as a service logic post-processing process, which functions to perform logic determining on a service side. An input of post-processing is the location information, the classification information, and determined grayscale contrasts respectively corresponding to the target object detection boxes output by the object detection model. An output is binary determining of whether each target object is detected or filtered. For a defect detection scenario, binary determining of OK/NG of the workpiece may alternatively be directly output.

In some embodiments of this disclosure, whether a target object in each target object detection box satisfies a detection requirement may be determined based on grayscale contrasts respectively corresponding to the at least one target object detection box. In this way, whether each target object is over-detected may be effectively distinguished. For example, using a defect detection scenario as an example, a visually significant defect and a visually insignificant defect can be effectively distinguished. For example, if a dark-colored foreign object appears on a white bottom surface, a grayscale contrast therebetween is very large, and the dark-colored foreign object is detected. However, if slight stains of dark gray appear on a gray interface, a grayscale contrast therebetween is very small, and the stains may be filtered out. In this way, a visible defect on a workpiece can be effectively detected, avoiding detection of a defect that may not be readily detected, and improving production efficiency and product quality.

In the object detection method provided in some embodiments of this disclosure, a difference between the foreground and the background of the target object detection box may be distinguished by calculating a grayscale contrast between a foreground region and a background region that are recognized, to filter out a detection result with an insignificant visual difference, to avoid an over-detection problem. In addition, the grayscale contrast can further assist in decision-making for service logic.

In embodiments of this disclosure, operation S103 of determining the first grayscale representative value of the pixels in the target object detection box may include:

Operation SA1: Determine, based on location information of the target object detection box, a weight corresponding to each pixel in the target object detection box, that is, determine, based on a position of each pixel in the target object detection box, a weight corresponding to each pixel.

The weight corresponding to each pixel represents impact of the pixel on the first grayscale representative value.

In some embodiments of this disclosure, the target object in the target object detection box may not occupy the entire rectangular detection box. For example, during actual industrial defect detection, a real defect form is usually irregular, and an output of the object detection model used in operation S102 is a rectangular detection box. This causes a difference between an actual defect form and the target object detection box. If the grayscale value in the target object detection box is directly calculated, there may be an error between the calculated foreground grayscale value and a grayscale value of a real target object. To address this, a corresponding weight may be set for each pixel in the target object detection box, to enhance impact of the real target object part on the first grayscale representative value and reduce impact of a difference part on the first grayscale representative value.

In embodiments, based on the location information of the target object detection box, information such as a size of the target object detection box and a quantity of pixels, a quantity of rows, and a quantity of columns of pixels in the target object detection box may be learned of, so that pixels whose weights need to be set may be determined.

The weight corresponding to each pixel in the target object detection box may be preset, or may be calculated according to a rule. This is not limited in some embodiments of this disclosure.

Operation SA2: Obtain a grayscale value of each pixel in the target object detection box.

In some embodiments of this disclosure, if the to-be-processed image is an RGB image, grayscale may be first performed on the to-be-processed image, to obtain a grayscale image corresponding to the to-be-processed image, and then a grayscale value of each pixel in each target object detection box is obtained from the grayscale image. An image grayscale manner may be selected according to an actual requirement. This is not limited in some embodiments of this disclosure. If the to-be-processed image is a grayscale image, a grayscale value of each pixel in each target object detection box may be directly obtained from the to-be-processed image.

Operation SA3: Perform weighted averaging on the grayscale value of each pixel in the target object detection box based on the weight corresponding to each pixel in the target object detection box, to obtain the first grayscale representative value of the pixels in the target object detection box.

The weight corresponding to each pixel in the target object detection box may be a two-dimensional matrix with the same size as the foreground. Assuming that each element in the matrix is represented as W₁(x, y), a contribution of each pixel in the target object detection box to the first grayscale representative value may be adjusted by using the weight matrix.

In embodiments, weighted averaging is performed on the grayscale value of each pixel in the target object detection box based on the weight corresponding to each pixel in the target object detection box. For the grayscale value P(x, y) of each pixel in the target object detection box, the first grayscale representative value Fg1 may be calculated by using the following formula:

$$Fg 1 = \frac{sum ( P ( x , y ) \times {W}_{1} ( x , y ) )}{sum ( {W}_{1} ( x , y ) )}$$

Alternatively, if the weight corresponding to each pixel in the target object detection box is a normalized two-dimensional matrix, and assuming that each element in the matrix is represented as W₂(x, y), the first grayscale representative value Fg1 may be calculated by using the following formula:

$$Fg 1 = sum ( P ( x , y ) * {W}_{2} ( x , y ) )$$

These formulas represent weighted averaging on the foreground grayscale value and the weight matrix thereof. In this manner, an average grayscale value of the foreground can be calculated more accurately, so as to compare grayscale contrasts more accurately.

As mentioned above, there may be a difference between an actual target object form and a rectangular detection box, considering that this may be because the rectangular detection box may include a part of the background. In view of this, in some embodiments of this disclosure, the weight corresponding to each pixel in the target object detection box may be set to such that a weight corresponding to a central pixel in the target object detection box is greater than a weight corresponding to an edge pixel in the target object detection box. The center and the edge in this disclosure may be considered to be relative, and for two positions, a weight of a pixel at the center is greater than a weight of a pixel at the edge.

In some embodiments of this disclosure, an exemplary implementation is provided for operation SA1. In embodiments, there is a gradual decrease from the weight corresponding to the central pixel in the target object detection box to the weight corresponding to the edge pixel in the target object detection box. A specific decreasing step may be set according to an actual situation. This is not limited in some embodiments of this disclosure.

In some embodiments of this disclosure, another exemplary implementation is provided for operation SA1. In embodiments, the implementation may include:

Operation SA11: Use a center position of the target object detection box as an origin of a two-dimensional Gaussian distribution function, and use a distance between the position of each pixel in the target object detection box and the center position as a variable of the two-dimensional Gaussian distribution function, to calculate a two-dimensional Gaussian distribution matrix.

Operation SA12: Determine each element value in the two-dimensional Gaussian distribution matrix as the weight corresponding to each pixel in the target object detection box.

Some embodiments of this disclosure aims to provide a weight corresponding to each pixel in a target object detection box, so that a weight of a pixel at the center of the rectangular detection box region (which is usually the center of a target object part) is larger, and a weight of a pixel at an edge (which may be a background) is smaller.

In some examples, the weight corresponding to each pixel in the target object detection box may be set to a Gaussian distribution weight matrix gaussian_weights. For some embodiments of this disclosure, based on the location information of the target object detection box, the center position of the target object detection box may be used as the origin of the two-dimensional Gaussian distribution function, and each pixel in the target object detection box may be used as the variable of the two-dimensional Gaussian distribution function, to calculate the two-dimensional Gaussian distribution matrix.

In two-dimensional space, a formula of the Gaussian distribution function is as follows:

$$f ( x , y ) = exp ( - \frac{{( x - {μ}_{x} )}^{2} + {( y - {μ}_{y} )}^{2}}{2 {σ}^{2}} )$$

x and y are coordinates in the two-dimensional space. μₓ and μ_{y} are average values. In some embodiments of this disclosure, μₓ and μ_{y} are set to 0, because it is hoped that the central pixel in the target object detection box has a largest weight. σ is a standard deviation.

Therefore, the two-dimensional Gaussian distribution matrix may be obtained as follows:

$$gaussian\_weights = exp ( - \frac{{x}^{2} + {y}^{2}}{2 {σ}^{2}} )$$

Similarly, the generated two-dimensional Gaussian distribution matrix gaussian_weights has the same size as the foreground, with the highest weight at the center and gradually decreased weights towards the periphery. If the two-dimensional Gaussian distribution matrix is determined as the weight corresponding to each pixel in the target object detection box, the contribution of each pixel in the target object detection box to the first grayscale representative value may be adjusted by using the weight matrix, so that the central pixel in the target object detection box has greater impact on the first grayscale representative value.

A manner and an effect of performing weighted averaging on the grayscale value of each pixel based on the two-dimensional Gaussian distribution matrix to obtain the first grayscale representative value of the pixels in the target object detection box are similar to those in operation SA3. Details are not described herein again.

In some examples, an objective of the foregoing foreground processing on the target object detection box is to calculate a grayscale contrast between the foreground and the background as accurately as possible, taking into account a difference between a real target object form and the rectangular detection box.

In some embodiments of this disclosure, operation S103 of determining the second grayscale representative value of the pixels in the background region may include:

Operation SB1: Cluster the pixels in the background region based on colors, to obtain at least two pixel sets. In this operation, the pixels in the background region are clustered based on color information of the pixels in the background region, to obtain at least two cluster centers and a clustering result of the pixels.

In some embodiments of this disclosure, to avoid a problem that when the target object is located in a region of complex texture, a region with a surrounding predetermined range may still be interfered with by the complex texture, resulting in inaccurate calculation of the second grayscale representative value, a clustering algorithm is used to filter a grayscale value of the specified background region, to reduce interference of the complex texture.

The grayscale value is used as the color information, that is, the grayscale value is used to implement clustering. Alternatively, an RGB value may be used as the color information, for example, the RGB value is directly used as a triple to implement clustering. This is not limited in some embodiments of this disclosure.

In some embodiments of this disclosure, an appropriate clustering algorithm may be selected according to an actual situation to cluster each pixel in the background region. For example, a K-Means clustering algorithm (an unsupervised learning algorithm, used for data clustering) may be used, or another algorithm like hierarchical clustering or density-based spatial clustering of applications with noise (DBSCAN, a density-based clustering algorithm) or a deep learning algorithm like autoencoder, deep embedding clustering (DEC), or density-based clustering (DBC) may be used. This is not limited in some embodiments of this disclosure. At least two cluster centers and a clustering result (that is, at least two pixel sets, each pixel set being a set of pixels belonging to one cluster) of pixels are finally obtained.

During actual application, an appropriate quantity of clusters may be determined according to a specific situation. For example, if background texture is very complex, the quantity of clusters may be increased. Increasing the quantity of clusters may enable finer division for the second grayscale representative value, thereby better processing the complex background texture. If background texture is simple and has less interference, a small quantity of clusters may be set, for example, two types of clusters are sufficient, to avoid calculation offset of the second grayscale representative value that may be caused by an excessive quantity of clusters, and reduce calculation complexity and running time.

Operation SB2: Update, based on grayscale values of the at least two cluster centers and the clustering result of the pixels, the grayscale value of each pixel in the background region used for calculating intermediate data. That is, this operation herein is a modification made to a data copy used for subsequent calculation, rather than to an original image. In embodiments, this operation may alternatively be omitted and replaced with another equivalent calculation method.

That is, in some embodiments of this disclosure, a cluster to which the pixel belongs is determined based on the clustering result of each pixel, and a grayscale value of the pixel is changed to a grayscale value of a corresponding cluster center. The updated grayscale value of each pixel is one of the grayscale values of the at least two cluster centers. For example, it is assumed that the quantity of clusters is set to 2, that is, the grayscale values of the background region are classified into two types.

Operation SB3: Determine the second grayscale representative value of the pixels in the background region based on the at least two pixel sets.

In this way, a relatively accurate second grayscale representative value may be obtained, and is used to calculate the grayscale contrast between the foreground region and the background region of the target object.

In some examples, the operation may include at least one of the following manners:

(1) Determine, based on the updated grayscale value of each pixel in the background region, a target grayscale value corresponding to a largest quantity of pixels in the grayscale values of the at least two cluster centers, and use the target grayscale value as the second grayscale representative value of the pixels in the background region.

For example, assuming that the grayscale values of the background region are classified into two types, which grayscale value in the two types of grayscale values corresponds to a large quantity of pixels may be determined, and a grayscale value with a largest quantity of pixels may be selected as the second grayscale representative value of the background region.

(2) Calculate an average value of updated grayscale values of the pixels in the background region, and use the average value as the second grayscale representative value of the pixels in the background region.

In embodiments, a sum of grayscale values of all the pixels in the background region may be calculated and then divided by the quantity of pixels to obtain the second grayscale representative value of the pixels in the background region. As mentioned above, in embodiments, the second grayscale representative value may alternatively be calculated without relying on updating a pixel value. For example, in an equivalent calculation method, a ratio of a quantity of pixels in each of the at least two pixel sets to a total quantity of pixels in the background region may be used as a weight of each pixel set, and the second grayscale representative value may be determined as a weighted average value, calculated by using the weight, of clustering target grayscale values respectively corresponding to the at least two pixel sets in the clustering process.

In any one of the foregoing manners, an average grayscale value of the background region can be calculated more accurately, so as to compare grayscale contrasts more accurately. During actual application, according to an actual situation, which second grayscale representative value calculation manner is used in which scenarios can be suitably selected. This is not limited in some embodiments of this disclosure. For example, using an actual industrial defect detection application as an example, if a defect is located near an edge of a component, a background region with a surrounding predetermined range may include the edge of the component and an environmental region outside the component. Interference of the environmental region on grayscale contrast calculation can be effectively filtered out by using the former manner of selecting the grayscale value with a largest quantity of pixels, thereby effectively improving determining accuracy.

In some embodiments of this disclosure, an exemplary implementation is provided for operation SB1. In embodiments, the implementation may include:

Operation SB11: Select a predetermined quantity of pixels as initial cluster centers in the background region.

This operation may be understood as an initialization operation. K (that is, a predetermined quantity) points are selected as the initial cluster centers, and the points may be randomly selected from the pixels in the background region.

Operation SB12: For each pixel in the background region, calculate a distance between the pixel and the predetermined quantity of cluster centers, and add each pixel to a set corresponding to a cluster center having a smallest distance to the pixel, to obtain a predetermined quantity of clusters (that is, the pixel set).

That is, the pixels in the background region are allocated. For each pixel, a distance between the pixel and each cluster center is calculated, and then the pixel is allocated to a nearest cluster center. In this way, K clusters can be obtained.

Operation SB13: Repeat the following clustering operations until a predetermined condition is met:

Operation SB131: For each obtained cluster, calculate an average value of all pixels in the cluster, and use the average value as an updated cluster center.

Operation SB132: For each pixel in the background region, calculate a distance between the pixel and each updated cluster center, and add each pixel to a pixel set corresponding to an updated cluster center having a smallest distance to the pixel, to obtain a predetermined quantity of updated clusters.

The predetermined condition may be set according to an actual situation, for example, the cluster center no longer changes, or a preset maximum quantity of iterations is reached. This is not limited in some embodiments of this disclosure. Finally, the K cluster centers and a clustering result of which cluster each pixel belongs may be obtained.

In some embodiments of this disclosure, the grayscale values of the background region are clustered, so as to reduce interference of complex texture and improve calculation accuracy of the second grayscale representative value. Filtering the grayscale value of the background region by using the foregoing clustering algorithm provides an effective method in an object detection solution like industrial defect detection, which helps accurately calculate the second grayscale representative value, thereby more accurately detecting the target object.

In some embodiments of this disclosure, operation S103 of determining the grayscale contrast between the first grayscale representative value and the second grayscale representative value may include:

Operation SC1: Calculate an absolute value of a difference between the first grayscale representative value and the second grayscale representative value.

Operation SC2: Use the absolute value of the difference as the grayscale contrast between the first grayscale representative value and the second grayscale representative value.

In some embodiments of this disclosure, calculating a grayscale contrast difference between the foreground and the background may be implemented by calculating an absolute difference between the first grayscale representative value and the second grayscale representative value. A calculation manner is as follows:

$$contrast = \vert fg\_mean - bg\_mean \vert$$

fg_mean is the first grayscale representative value (which may be, for example, a weighted average grayscale value of the foreground), and bg_mean is the second grayscale representative value (which may be, for example, an average grayscale value of the background). The absolute difference may be used to evaluate a contrast between the foreground and the background. A larger contrast indicates a more significant target object.

In some embodiments of this disclosure, an exemplary implementation is provided for operation S104. In embodiments, the implementation may include:

Operation S1041: For each target object detection box, determine whether a grayscale contrast corresponding to the target object detection box is greater than a predetermined threshold.

Operation S1042: Filter out a target object detection box whose grayscale contrast is less than the predetermined threshold. The filtering operation may be deleting corresponding data, or annotating the data. In embodiments, this operation may alternatively not be performed, but operation S1043 is directly performed.

Operation S1043: Use classification information of the target object and location information of a target object detection box whose grayscale contrast is greater than the predetermined threshold in the at least one target object detection box as the detection result of the to-be-detected image.

In some embodiments of this disclosure, a related detection parameter, that is, the predetermined threshold, may be preset, for example, 50. A target object whose absolute value of a grayscale contrast is greater than the predetermined threshold may be detected. For example, a significant defect (for example, severe dirt, but not limited thereto) may be detected, while a visually similar target object, for example, an insignificant defect (for example, slight dirt, but not limited thereto) may be filtered, thereby implementing a function of accurate target object detection.

In embodiments, for a to-be-processed image in which at least one target object detection box whose grayscale contrast is greater than the predetermined threshold exists, there is a detection result for the to-be-processed image. Using a defect detection scenario as an example, if there is a defective workpiece in the to-be-processed image, a quality inspection result of NG may be output for the to-be-processed image, and a defect position and a defect classification of the to-be-processed image, for example, dirt, discoloration, scratch, damage, or dent, may also be output, but this is not limited thereto.

For a to-be-processed image in which the target object detection box whose grayscale contrast is greater than the predetermined threshold does not exist, there is no detection result for the to-be-processed image. Using a defect detection scenario as an example, if there is no defective workpiece in the to-be-processed image, a quality inspection result of OK may be output for the to-be-processed image.

The object detection method provided in some embodiments of this disclosure may avoid detecting a visually insignificant target object, thereby improving detection accuracy.

In some embodiments of this disclosure, an exemplary implementation is provided for operation S102. In embodiments, the implementation may include:

Operation S1021: Obtain a grayscale image of the to-be-detected image.

Operation S1022: Concatenate the grayscale image of the to-be-detected image and the to-be-detected image, to obtain an input image of the object detection model.

Operation S1023: Extract an image feature of the input image by using the object detection model, obtain an initial preselected region, and perform regression and classification on the initial preselected region for a plurality of times based on the image feature, to obtain classification information of the target object and location information of the at least one target object detection box.

In some embodiments of this disclosure, the object detection model based on deep learning is to implement detection and identification of a defect under conditions of common imaging visibility and common distinguishability.

A quantity of input channels of the object detection model is four. To be specific, an RGB color image corresponding to the to-be-detected image has three channels, and a differential contrast grayscale image of the to-be-detected image has one channel. After concatenation, the input image has four channels.

In some examples, as shown in FIG. 5, an image feature of an input image is extracted by using an object detection model. In FIG. 5, I represents the input image. CONV represents a backbone network, which may be an HRNetV2P network, a ResNet network, a Swin Transformer network, or the like, but not limited thereto, for extracting the image feature of the input image. B0 represents an obtained initial preselected region, which may alternatively be processed through a neural network, for example, a region proposal network (RPN), but this is not limited thereto. POOL represents a local region feature extractor (for example, a region of interest (ROI) Pooling operation is performed). H1 to H3 represent network headers. B1 to B3 represent target regions (location information of a target object detection box) obtained by performing hierarchical regression on the initial preselected region. C1 to C3 represent classification results obtained by performing hierarchical classification on the initial preselected region. Regression and classification of each level are performed based on a previous level. Such a cascaded detection manner can improve detection accuracy.

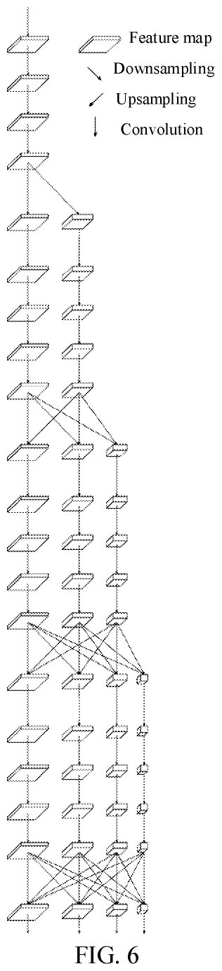

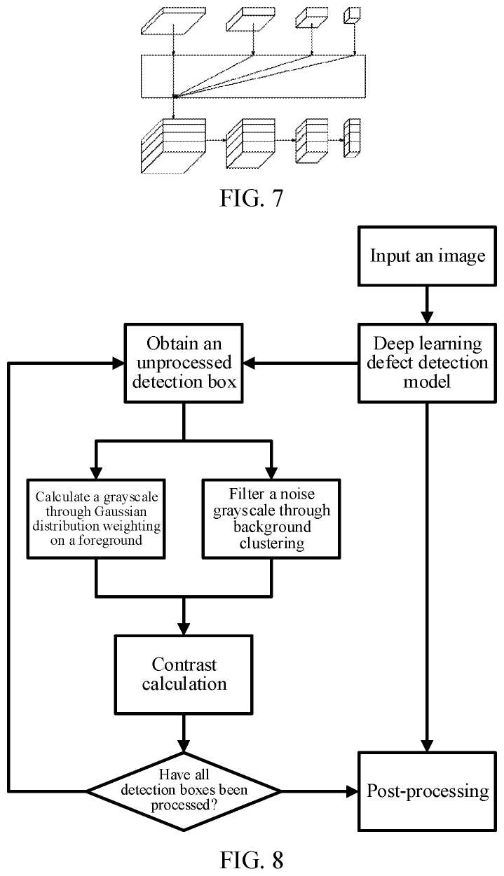

In some embodiments of this disclosure, the backbone network in the object detection model may use a feature extraction network shown in FIG. 6 and a feature fusion network shown in FIG. 7. The feature extraction network has a strong capability of extracting panoramic information, and has an excellent effect of workpiece defect detection in an industrial scenario. In some examples, the feature extraction network may gradually increase features of different scales obtained through downsampling, process features of a plurality of scales in parallel, and share feature information in the features of various scales for a plurality of times, to obtain feature maps of a plurality of scales that include sufficient semantic information and texture information. The feature maps of a plurality of scales are fused through the feature fusion network, to obtain the image feature of the input image, so that the image feature is more accurate both spatially and semantically.

In some embodiments of this disclosure, an object detection network may perform end-to-end training. In embodiments, there may be supervised training, and a training set includes annotation information of a position and a classification of a target object. Using a defect detection scenario as an example, all to-be-detected parts including various types of defects may be prepared. A defect position and a defect classification are annotated on a part image (for example, a boundary box of defects such as dirt and discoloration that need to be detected is annotated), and the model is trained. During inference, only a corresponding trained network parameter may need to be loaded, and an image is directly input to obtain a model output result. During inference, an input of the object detection network is concatenation of an RGB color image and a differential contrast grayscale image, and an output is boundary boxes and classifications (or confidence probabilities of the classifications) of dirt, discoloration, scratch, damage, dent, and the like.

In some embodiments of the disclosure, a loss function for training the object detection model is the same as a loss function of an original model, including a regression loss term for fitting and regressing detection box coordinates (x, y, w, h), and a classification loss term for supervising and constraining a detection box classification. This process may be represented by using the following formula:

$$Loss = L\_reg ( x , y , w , h ) + L\_cls ( c )$$

L_reg is the regression loss term for fitting and regressing the detection box. L_cls is the classification loss term for supervising and constraining the detection box classification. x, y, w, h respectively represent center coordinates, a width, and a height of the detection box. c represents the detection box classification.

In a training process, a large quantity of annotated samples may be used to train a model, so that the model can learn how to accurately identify and locate a defect. This process requires a large amount of computing resources and time, but once the model is trained, defect detection can be rapidly and accurately performed during actual production.

In addition, in a model training process in some embodiments of this disclosure, only the object detection model is trained, and operations in the remaining procedure are all determined, without any learnable parameters. Therefore, the technical solutions provided in some embodiments of this disclosure do not need cumbersome parameter adjustment work when applied to a new console, and possess good compatibility. This is because only one threshold needs to be set, to determine, based on the grayscale contrast of the detection box, whether a defect needs to be detected. Compared with a related deep learning method, this method is simpler, easier to implement, does not need additional manual annotation, and can be applied to an actual scenario in which rapid deployment and iteration need to be performed.

In some examples, in the object detection method provided in some embodiments of this disclosure, the target object can be effectively detected by jointly using a deep neural network model and a service logic post-processing module, and calculating the grayscale contrast between the foreground and the background. In some examples, during object detection, noise may be filtered through Gaussian weighting on the foreground and background clustering, and both the difference between the real target object form and the rectangular detection box, and an actual requirement on the service side are considered. In this way, the contrast between the foreground and the background is calculated more accurately, and decision-making can also be assisted, thus having a very high application value during actual production.

Based on at least one of the foregoing embodiments, in some embodiments of this disclosure, a defect detection scenario is used as an example. FIG. 8 provides an example of a procedure of a defect detection method. In embodiments, the method may include:

Operation S8.1: Input a to-be-detected image. The to-be-detected image is usually a high-definition image of a workpiece, and may include various possible defects. The to-be-detected image is input into a deep learning object detection network (which may be a defect detection network). The neural network is trained in advance, can identify and locate a defect in the image, and output several defect detection boxes. Each defect detection box represents a possible defect region.

Operation S8.2: Process each defect detection box. First, a foreground grayscale value (that is, a first grayscale representative value) in the defect detection box is calculated. A foreground is usually a defect, and an average value of grayscale values thereof may be calculated or a grayscale may be calculated through Gaussian distribution weighting on the foreground, to represent a color and brightness thereof.

Operation S8.3: Calculate a background grayscale value (that is, a second grayscale representative value) surrounding the defect detection box. A background is usually a normal part of the workpiece. An average value of grayscale values of the background may be calculated, or a noise grayscale is filtered through background clustering.

Operation S8.4: Calculate an absolute value of a difference between the foreground grayscale value and the background grayscale value. The absolute value of the difference may be used to evaluate a contrast between the defect and the background. A larger contrast indicates a more significant defect.

Operation S8.5: Perform such processing on all the defect detection boxes, to finally obtain a grayscale contrast of each defect detection box.

Operation S8.6: Send grayscale contrasts of all the defect detection boxes to a post-processing module. In the post-processing module, a threshold is set according to service logic. If a grayscale contrast of a detection box is greater than the threshold, it is considered that this is an NG defect and needs to be detected, and location information and classification information of the defect are obtained from an output result of a defect detection model for output. If a grayscale contrast is less than the threshold, it is considered that this is a defect that can be ignored, and filtering may be performed.

In the defect detection method provided in some embodiments of this disclosure, a to-be-processed image is preprocessed to construct a corresponding deep neural network (a defect detection network), so as to detect a plurality of types of surface defects such as dirt, discoloration, scratch, damage, and dent of a workpiece. After detecting the foreground, Gaussian distribution weighting on the foreground and surrounding background clustering can be performed to filter noise, a grayscale difference absolute value is calculated, and a contrast between a foreground and a background of a detection box is accurately calculated. The contrast may be used to distinguish between a visually significant defect and a visually insignificant defect. This can not only improve a detection rate of the visually significant defect (for example, by lowering a score threshold to improve a detection rate of a neural network, and then using this solution to filter out the visually insignificant defect), but also assist in decision-making for service logic.

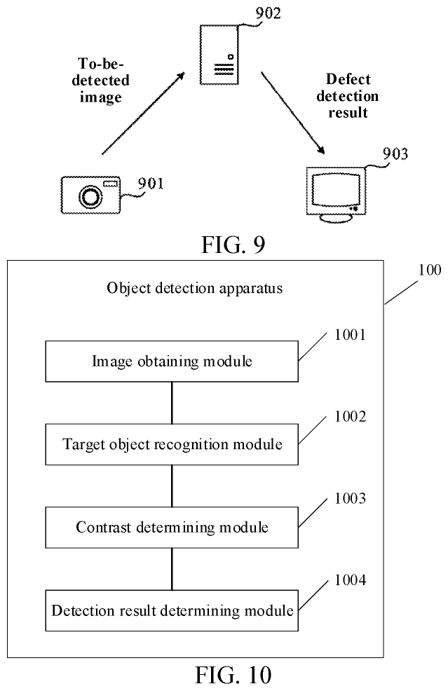

In embodiments, the object detection solution provided in embodiments of this disclosure may alternatively be cooperatively completed by a plurality of computer devices or components having a computing capability. For example, different computer devices or components respectively complete some operations of the methods provided in embodiments of this disclosure. For example, as shown in FIG. 9, the solution may be cooperatively completed by a capturing device 901, a computing device 902, and a display device 903 that are connected through a network. The capturing device 901 is configured to capture an image to obtain a to-be-detected image. The computing device 902 is configured to process the image captured by the capturing device 901, for example, perform defect detection and determining. The display device 903 is configured to display a defect detection result processed by the computing device 902, where the defect detection result may include a defect position and a defect type. The capturing device 901 may include, but is not limited to, image capturing devices such as a camera and a webcam. In some embodiments, when the computing device 902 has a display function, the display device 903 may be a display in the computing device 902.

An object detection method based on a grayscale contrast provided in embodiments of this disclosure, for example, an industrial defect detection method, may be applied to the field of defect detection and product quality control, for example, steel plate defect detection, floor flaw detection, printed circuit board (PCB) defect detection, film defect detection, lamp ball defect detection, metal bar end face detection, fabric wrinkle grade evaluation, and automated quality inspection instruments for surface defects of industrial parts.

The object detection method provided in embodiments of this disclosure has the following technical effects:

(1) A network structure is clear, each module has a good generalization capability, and experiments on popular industrial quality inspection data sets indicate that this solution has good and stable performance, with a high recall rate and a low pass rate for defects.

(2) Algorithm logic is clear, stable, and controllable, and an operation result of each branch can be viewed visually, to help quickly locate a problem when the algorithm works abnormal.

(3) Better interpretability is provided. An intuitive feature can be obtained through grayscale difference calculation, and this feature can assist in a service decision-making process. A contrast difference is intuitive and easy to adjust.

(4) Calculation accuracy of a grayscale contrast is high. This solution can also implement grayscale contrast calculation with high accuracy in a rectangular detection box without requiring complex operations and annotation work of a segmentation network (for a polygonal defect, the segmentation network needs to annotate a plurality of points (>10) based on the defect, which slows down annotation and model training iteration speeds, and a segmentation model usually needs to consume more time and occupy a video memory during inference, where various factors may make the application of the segmentation model in actual industrial detection more difficult), thus improving practicability of industrial detection deployment.

Some embodiments of the present disclosure provide an object detection apparatus. As shown in FIG. 10, the object detection apparatus 100 may include: an image obtaining module 1001, a target object recognition module 1002, a contrast determining module 1003, and a detection result determining module 1004.

The image obtaining module 1001 is configured to obtain a to-be-detected image.

The target object recognition module 1002 is configured to recognize a target object in a to-be-detected image by using an object detection model, to obtain at least one target object detection box.

The contrast determining module 1003 is configured to: for each target object detection box, determine a first grayscale representative value of pixels in the target object detection box, determine a second grayscale representative value of pixels in a background region of the target object detection box, and determine a grayscale contrast between the first grayscale representative value and the second grayscale representative value, the background region being a region with a predetermined range surrounding the target object detection box.

The detection result determining module 1004 is configured to determine a target object detection box whose grayscale contrast satisfies a preset condition in the at least one target object detection box as a detection result of the to-be-detected image.

In embodiments, when being configured to determine the first grayscale representative value of the pixels in the target object detection box, the contrast determining module 1003 is configured to: determine, based on a position of each pixel in the target object detection box, a weight corresponding to each pixel; and perform weighted averaging on a grayscale value of each pixel in the target object detection box based on the weight corresponding to each pixel in the target object detection box, to obtain the first grayscale representative value of the pixels in the target object detection box; or configured to: determine, based on location information of the target object detection box, a weight corresponding to each pixel in the target object detection box, the weight corresponding to each pixel representing impact of the pixel on the first grayscale representative value; obtain a grayscale value of each pixel in the target object detection box; and perform weighted averaging on the grayscale value of each pixel based on the weight corresponding to each pixel, to obtain the first grayscale representative value of the pixels in the target object detection box.

In embodiments, a weight corresponding to a central pixel in the target object detection box is greater than a weight corresponding to an edge pixel in the target object detection box.

In embodiments, when being configured to determine, based on the location information of the target object detection box, the weight corresponding to each pixel in the target object detection box, the contrast determining module 1003 is configured to: use a center position of the target object detection box as an origin of a two-dimensional Gaussian distribution function, and use a distance between the position of each pixel in the target object detection box and the center position as a variable of the two-dimensional Gaussian distribution function, to calculate a two-dimensional Gaussian distribution matrix; and determine each element value in the two-dimensional Gaussian distribution matrix as the weight corresponding to each pixel in the target object detection box.

In embodiments, when being configured to determine the second grayscale representative value of the pixels in the background region, the contrast determining module 1003 is configured to: cluster the pixels in the background region based on colors, to obtain at least two pixel sets; and determine the second grayscale representative value of the pixels in the background region based on the at least two pixel sets.

In embodiments, when being configured to determine the second grayscale representative value of the pixels in the background region based on an updated grayscale value of each pixel in the background region, the contrast determining module 1003 is used in at least one of the following manners: determining a pixel set with a largest quantity of pixels in the at least two pixel sets, and using a clustering target grayscale value corresponding to the pixel set with the largest quantity of pixels in the at least two pixel sets in the clustering process as the second grayscale representative value; and calculating an average value of updated grayscale values of pixels in the background region, and using the average value as the second grayscale representative value of the pixels in the background region.

In embodiments, when being configured to cluster the pixels in the background region based on color information of the pixels in the background region, the contrast determining module 1003 is configured to: select a predetermined quantity of pixels as initial cluster centers in the background region; for each pixel in the background region, calculate a distance between the pixel and a predetermined quantity of cluster centers, and add each pixel to a set corresponding to a cluster center having a smallest distance to the pixel, to obtain a predetermined quantity of clusters; and repeat the following clustering operations until a predetermined condition is met: for each obtained cluster, calculate an average value of all pixels in the pixel set, and use the average value as an updated cluster center; and for each pixel in the background region, calculate a distance between the pixel and each updated cluster center, and add each pixel to a pixel set corresponding to an updated cluster center having a smallest distance to the pixel, to obtain a predetermined quantity of updated pixel sets.

In embodiments, when being configured to determine the grayscale contrast between the first grayscale representative value and the second grayscale representative value, the contrast determining module 1003 is configured to: calculate an absolute value of a difference between the first grayscale representative value and the second grayscale representative value; and use the absolute value of the difference as the grayscale contrast between the first grayscale representative value and the second grayscale representative value.

In embodiments, when being configured to determine the detection result of the to-be-detected image based on grayscale contrasts respectively corresponding to the at least one target object detection box, the detection result determining module 1004 is configured to: for each of the at least one target object detection box, determine whether a grayscale contrast corresponding to the target object detection box is greater than a predetermined threshold; and use classification information of the target object and location information of a target object detection box whose grayscale contrast is greater than the predetermined threshold in the at least one target object detection box as the detection result of the to-be-detected image.

In embodiments, when being configured to recognize the target object in the to-be-detected image by using the object detection model, to obtain the at least one target object detection box, the target object recognition module 1002 is configured to: obtain a grayscale image of the to-be-detected image; concatenate the grayscale image of the to-be-detected image and the to-be-detected image, to obtain an input image of the object detection model; and extract an image feature of the input image by using the object detection model, obtain an initial preselected region, and perform regression and classification on the initial preselected region for a plurality of times based on the image feature, to obtain classification information of the target object and location information of the at least one target object detection box.

The apparatus of embodiments of this disclosure may perform the method according to embodiments of this disclosure, and the implementation principles of the apparatus and the method are similar. The actions performed by the modules in the apparatus of embodiments of this disclosure correspond to the operations in the method according to embodiments of this disclosure. For detailed functional descriptions and generated beneficial effects of the modules of the apparatus, reference may be made to the descriptions of the corresponding method shown in the foregoing descriptions, and details are not described herein again.

Some embodiments of this disclosure provide an electronic device, including a memory, a processor, and a computer program stored in the memory, and the processor, when executing the computer program, implementing the operations of the foregoing method embodiments.

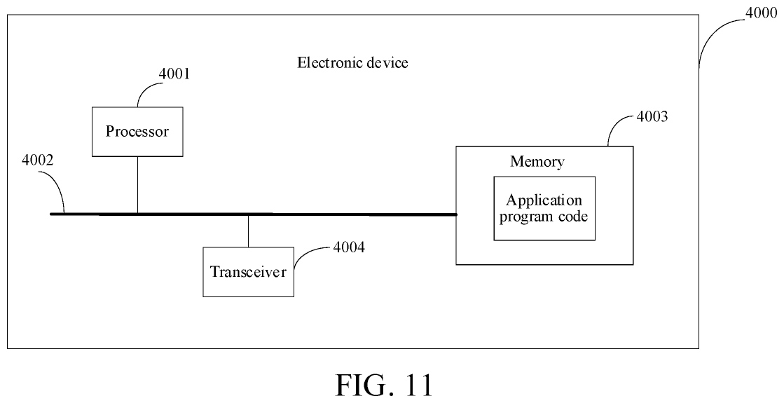

Some embodiments of this disclosure provide an electronic device. As shown in FIG. 11, the electronic device 4000 shown in FIG. 11 includes a processor 4001 and a memory 4003. The processor 4001 is connected to the memory 4003, for example, through a bus 4002. In embodiments, the electronic device 4000 may further include a transceiver 4004, and the transceiver 4004 may be configured to perform data interaction between the electronic device and another electronic device, such as data sending and/or data receiving. During actual application, the transceiver 4004 is not limited to one, and a structure of the electronic device 4000 does not constitute a limitation to some embodiments of this disclosure.

The processor 4001 may be a central processing unit (CPU), a general-purpose processor, a digital signal processor (DSP), an application-specific integrated circuit (ASIC), a field programmable gate array (FPGA), or another programmable logic device, a transistor logic device, a hardware component, or any combination thereof. The processor 4001 may implement or execute various logical blocks, modules, and circuits described with reference to content disclosed in this disclosure. The processor 4001 may also be a combination implementing a computing function, for example, a combination including one or more microprocessors, or a combination of a DSP and a microprocessor.

The bus 4002 may include a path for transmitting information between the foregoing components. The bus 4002 may be a peripheral component interconnect (PCI) bus, an extended industry standard architecture (EISA) bus, or the like. The bus 4002 may be classified into an address bus, a data bus, a control bus, and the like. For ease of representation, only one thick line is used to represent the bus in FIG. 11, but this does not mean that there is only one bus or only one type of bus.

The memory 4003 may be a read-only memory (ROM) or another type of static storage device that can store static information and instructions, a random access memory (RAM) or another type of dynamic storage device that can store information and instructions, an electrically erasable programmable read-only memory (EEPROM), a compact disc read-only memory (CD-ROM) or another optical disc storage, an optical disc storage (including a compact optical disc, a laser disc, an optical disc, a digital versatile optical disc, a Blu-ray disc, and the like), a magnetic disk storage medium or another magnetic storage device, or any other medium capable of carrying or storing a computer program and capable of being read by a computer. This is not limited thereto.

The memory 4003 is configured to store a computer program for performing embodiments of this disclosure, and is controlled and executed by the processor 4001. The processor 4001 is configured to execute the computer program stored in the memory 4003, to implement the operations shown in the foregoing method embodiments.

Some embodiments of this disclosure provide a computer-readable storage medium, the computer-readable storage medium having a computer program stored therein. The computer program, when executed by a processor, may implement the operations and corresponding content of the foregoing method embodiments.

Some embodiments of this disclosure further provide a computer program product, including a computer program. The computer program, when executed by a processor, may implement the operations and corresponding content of the foregoing method embodiments.

The terms such as “first”, “second”, “third”, “fourth”, “1”, and “2” (if any) in the specification and claims of this disclosure and in the foregoing accompanying drawings are used for distinguishing similar objects and not necessarily used for describing any particular order or sequence. Such used data is interchangeable where appropriate so that embodiments of this disclosure described herein can be implemented in an order other than those illustrated or described in the text.

Although operation steps are indicated by arrows in the flowcharts of embodiments of this disclosure, an implementation order of the operations is not limited to the order indicated by the arrows. Unless explicitly described in this specification, in some implementation scenarios of embodiments of this disclosure, implementation operations in the flowcharts may be performed in another order according to requirements. In addition, some or all of the operations in the flowcharts may include a plurality of sub-operations or a plurality of stages based on an actual implementation scenario. Some or all of these sub-operations or stages may be performed at the same moment, and each of these sub-operations or stages may be separately performed at different moments. In a scenario with different execution moments, an execution order of these sub-operations or stages may be flexibly configured according to a requirement. This is not limited in embodiments of this disclosure.

Technical features of the foregoing embodiments may be combined in various manners. To make descriptions concise, not all possible combinations of the technical features in the foregoing embodiments are described. However, the combinations of these technical features shall be considered as falling within the scope recorded by this specification provided that no conflict exists.

One or more modules, submodules, and/or units of the apparatus can be implemented by processing circuitry, software, or a combination thereof, for example. The term module (and other similar terms such as unit, submodule, and the like) in this disclosure may refer to a software module, a hardware module, or a combination thereof. A software module (for example, a computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of object detection, the method comprising:
obtaining, in a to-be-detected image, one or more candidate target object detection boxes that respectively include a target object that is recognized by using an object detection model;
for each candidate target object detection box in the one or more candidate target object detection boxes:
determining a first grayscale representative value of first pixels in the candidate target object detection box,
determining a second grayscale representative value of second pixels in a background region of the candidate target object detection box, the background region being a region with a predetermined range surrounding the candidate target object detection box, and
determining a grayscale contrast of the candidate target object detection box between the first grayscale representative value and the second grayscale representative value; and
obtaining a detection result of the to-be-detected image based on the grayscale contrasts of the one or more candidate target object detection boxes and a preset condition.

2. The method according to claim 1, wherein the determining the first grayscale representative value comprises:
determining respective weights of the first pixels based on respective positions of the first pixels in the candidate target object detection box; and
calculating the first grayscale representative value as a weighted average of grayscale values of the first pixels based on the respective weights of the first pixels.

3. The method according to claim 2, wherein a first weight of a central pixel in the candidate target object detection box is greater than a second weight of an edge pixel in the candidate target object detection box.

4. The method according to claim 3, wherein the determining the respective weights of the first pixels comprises:
using a center position of the candidate target object detection box as an origin of a two-dimensional Gaussian distribution function;
calculating a two-dimensional Gaussian distribution matrix with elements corresponding to the first pixels in the candidate target object detection box, an element corresponding to a pixel in the first pixels being calculated using the two-dimensional Gaussian distribution function according to a distance between the pixel to the center position; and
determining the respective weights of the first pixels according to the elements in the two-dimensional Gaussian distribution matrix.

5. The method according to claim 1, wherein the determining the second grayscale representative value comprises:
clustering the second pixels in the background region based on colors, to obtain at least two pixel sets; and
determining the second grayscale representative value based on the at least two pixel sets.

6. The method according to claim 5, wherein the determining the second grayscale representative value based on the at least two pixel sets comprises:
determining a pixel set in the at least two pixel sets that has a largest quantity of pixels; and
using a clustering target grayscale value that is used to obtain the pixel set during the clustering as the second grayscale representative value.

7. The method according to claim 5, wherein the determining the second grayscale representative value based on the at least two pixel sets comprises:
calculating respective pixel quantity ratios of the at least two pixel sets to a total pixel quantity in the background region;
determining respective weights of the at least two pixel sets based on the pixel quantity ratios;
calculating, based on the weights of the at least two pixel sets, a weighted average value of clustering target grayscale values that are used to obtain the at least two pixel sets during the clustering; and
determining the second grayscale representative value according to the weighted average value.

8. The method according to claim 5, wherein the clustering comprises:
selecting a predetermined quantity of pixel values in the background region as initial cluster centers respectively for a predetermined quantity of pixel sets;
clustering the second pixels respectively to the predetermined quantity of pixel sets according to value distances to the initial cluster centers, a pixel in the second pixels being clustered into a first pixel set with a first initial cluster center of the initial cluster centers when a value distance of the pixel to the first initial cluster center being a smallest value distance among value distances of the pixel to the initial cluster centers; and
performing one or more update rounds until a predetermined condition is met, an update round in the one or more update rounds comprising:
calculating updated cluster centers respectively for the predetermined quantity of pixel sets according to average pixel values in the predetermined quantity of pixel sets; and
clustering the second pixels respectively to the predetermined quantity of pixel sets according to value distances to the updated cluster centers.

9. The method according to claim 1, wherein the determining the grayscale contrast comprises:
calculating an absolute value of a difference between the first grayscale representative value and the second grayscale representative value; and
using the absolute value of the difference as the grayscale contrast between the first grayscale representative value and the second grayscale representative value.

10. The method according to claim 1, wherein the obtaining the detection result comprises:
determining location information of at least a target object detection box in the one or more candidate target object detection boxes that has a grayscale contrast greater than a predetermined threshold; and
using classification information of the target object and the location information as the detection result of the to-be-detected image.

11. The method according to claim 1, further comprising:
obtaining a grayscale image of the to-be-detected image;
concatenating the grayscale image of the to-be-detected image and the to-be-detected image, to obtain an input image of the object detection model;
extracting an image feature of the input image by using the object detection model; and
performing regression and classification on an initial preselected region for a plurality of times based on the image feature, to obtain classification information of the target object and location information of the one or more candidate target object detection boxes.

12. An apparatus of object detection, comprising processing circuitry configured to:
obtain, in a to-be-detected image, one or more candidate target object detection boxes that respectively include a target object that is recognized by using an object detection model;
for each candidate target object detection box in the one or more candidate target object detection boxes:
determine a first grayscale representative value of first pixels in the candidate target object detection box,
determine a second grayscale representative value of second pixels in a background region of the candidate target object detection box, the background region being a region with a predetermined range surrounding the candidate target object detection box, and
determine a grayscale contrast of the candidate target object detection box between the first grayscale representative value and the second grayscale representative value; and
obtain a detection result of the to-be-detected image based on the grayscale contrasts of the one or more candidate target object detection boxes and a preset condition.

13. The apparatus according to claim 12, wherein the processing circuitry is configured to:
determine respective weights of the first pixels based on respective positions of the first pixels in the candidate target object detection box; and
calculate the first grayscale representative value as a weighted average of grayscale values of the first pixels in the candidate target object detection box based on the respective weights of the first pixels.

14. The apparatus according to claim 13, wherein a first weight of a central pixel in the candidate target object detection box is greater than a second weight of an edge pixel in the candidate target object detection box.

15. The apparatus according to claim 14, wherein the processing circuitry is configured to:
use a center position of the candidate target object detection box as an origin of a two-dimensional Gaussian distribution function;
calculate a two-dimensional Gaussian distribution matrix with elements corresponding to the first pixels in the candidate target object detection box, an element corresponding to a pixel in the first pixels being calculated using the two-dimensional Gaussian distribution function according to a distance between the pixel to the center position; and
determine the respective weights of the first pixels according to the elements in the two-dimensional Gaussian distribution matrix.

16. The apparatus according to claim 12, wherein the processing circuitry is configured to:
cluster the second pixels in the background region based on colors, to obtain at least two pixel sets; and
determine the second grayscale representative value based on the at least two pixel sets.

17. The apparatus according to claim 16, wherein the processing circuitry is configured to:
determine a pixel set in the at least two pixel sets that has a largest quantity of pixels; and
use a clustering target grayscale value that is used to obtain the pixel set during the clustering as the second grayscale representative value.

18. The apparatus according to claim 16, wherein the processing circuitry is configured to:
calculate respective pixel quantity ratios of the at least two pixel sets to a total pixel quantity in the background region;
determine respective weights of the at least two pixel sets based on the pixel quantity ratios;
calculate, based on the weights of the at least two pixel sets, a weighted average value of clustering target grayscale values that are used to obtain the at least two pixel sets during the clustering; and
determine the second grayscale representative value according to the weighted average value.

19. The apparatus according to claim 16, wherein the processing circuitry is configured to:
select a predetermined quantity of pixel values in the background region as initial cluster centers respectively for a predetermined quantity of pixel sets;
cluster the second pixels respectively to the predetermined quantity of pixel sets according to value distances to the initial cluster centers, a pixel in the second pixels being clustered into a first pixel set with a first initial cluster center of the initial cluster centers when a value distance of the pixel to the first initial cluster center being a smallest value distance among value distances of the pixel to the initial cluster centers; and
perform one or more update rounds until a predetermined condition is met, an update round in the one or more update rounds comprising:
calculating updated cluster centers respectively for the predetermined quantity of pixel sets according to average pixel values in the predetermined quantity of pixel sets; and
clustering the second pixels respectively to the predetermined quantity of pixel sets according to value distances to the updated cluster centers.

20. A non-transitory computer-readable storage medium storing instructions which when executed by at least one processor cause the at least one processor to perform:
obtaining, in a to-be-detected image, one or more candidate target object detection boxes that respectively include a target object that is recognized by using an object detection model;
for each candidate target object detection box in the one or more candidate target object detection boxes:
determining a first grayscale representative value of first pixels in the candidate target object detection box,
determining a second grayscale representative value of second pixels in a background region of the candidate target object detection box, the background region being a region with a predetermined range surrounding the candidate target object detection box, and
determining a grayscale contrast of the candidate target object detection box between the first grayscale representative value and the second grayscale representative value; and
obtaining a detection result of the to-be-detected image based on the grayscale contrasts of the one or more candidate target object detection boxes and a preset condition.
